(19) United States
(12) Patent Application Publication
(10) Pub. No.: US 2026/0344589 A1
(43) Pub. Date: Nov. 5, 2026

(54) BIOCHAR CULTURE MEDIUM AND METHOD FOR PRODUCING SAME

(71) Applicant: TOWING CO., LTD., Nagoya-shi, Aichi (JP)

(72) Inventors: Ryoya NISHIDA, Nagoya-shi (JP); Kohei NISHIDA, Nagoya-shi (JP); Shunsuke KIMURA, Nagoya-shi (JP)

(73) Assignee: TOWING CO., LTD., Nagoya-shi, Aichi (JP)

(21) Appl. No.: 19/120,351

(22) PCT Filed: Oct. 12, 2023
(86) PCT No.: PCT/JP2023/037115

§ 371 Date: Apr. 11, 2025

(30) Foreign Application Priority Data
Oct. 12, 2022 (JP) 2022-164205

(51) Int. Cl. A01G 24/10; A01G 24/20; A01G 24/42

(52) U.S. Cl. CPC A01G 24/10; A01G 24/20; A01G 24/42

(57) ABSTRACT

Biochar culture medium having pH buffering capacity, containing a biochar, a biostimulant material, and a beneficial microorganism.

### TECHNICAL FIELD

The present invention relates to biochar culture media and methods for producing the same. More particularly, it relates to biochar culture media having pH buffering capacity that, when used, can prevent the increase in pH, and methods for producing the same.

### BACKGROUND ART

Plant-derived char such as charcoal (hereinafter referred to as “biochar”) is used as a material for improving the soil for cultivation of plants. Biochar can be produced, for example, by heating biomass such as charcoal or bamboo charcoal at temperatures above 350 ° C under oxygen concentrations controlled to levels that do not burn. Biochar is porous, and thus can be applied to the soil to increase the gaseous phase ratio of the soil and improve its water and air permeability. Biochar can also maintain not only aeration but also adequate water retention in the soil, thus creating suitable environment for propagation of beneficial microorganisms. In addition, biochar contains minerals, and thus can supply minerals to the soil to promote plant growth. Furthermore, biochar can be produced from agricultural waste, and thus is favorable for creating an environmentally friendly and sustainable society with less waste materials.

In recent years, biochar has been increasingly used not only as a soil amendment but also as an artificial soil substrate.

However, soils made of biochar alone or soils with a large amount of biochar added are sometimes alkaline. This is because minerals contained in biochar, such as potassium and calcium, are leached out and added to the soil due to rainfall or irrigation. Adding biochar to acidic soils can neutralize them and create an environment in which plants can grow easily, but if the soils become highly alkaline, components such as phosphoric acid and iron may become insoluble, causing physiological disorders and poor germination of plants.

To prevent the soil with the addition of biochar from being highly alkaline, irrigation of the soil with large amounts of water has been conventionally performed. However, this requires a substantial amount of water and is not economically viable. Moreover, even after adding water to soil that has already become highly alkaline, the pH does not decrease immediately, resulting in a prolonged period of high alkalinity. Additionally, there is a potential risk of propagation of anaerobic microorganisms that produce ammonia gas.

Attempts have also been made to mix biochar with acidic materials or immerse biochar in a liquid containing dissolved acidic materials. While these approaches initially suppressed the rise in pH, their effects did not last long, with the pH rising within approximately two weeks, making the suppression of high alkalinity insufficient.

Regarding technology for adjusting pH by adding acidic liquids, there exists a greening material, comprising biochar that has a pH of 5.0 to 8.0 by addition of acidic liquid and retains one or more of the following strains: Suillus granulatus 1140-TK44 strain (NITE AP-01658) of the family Boletaceae, Lyophyllum fumosum 273-TS49 strain (NITE AP-01659) of the family Tricholamataceae, and Glomus KANSO-19 strain, and its manufacturing method (Patent Document 1). The greening material and manufacturing method described in Patent Document 1 allow for proliferation and stable retention of specific symbiotic microorganisms that coexist with host plants by adjusting the biochar to a slightly acidic to neutral pH through the addition of the acidic liquid. However, the greening material and its production method described in Patent Document 1 is an improvement technology in the field of technology to promote the growth of host plants, improve the resistance to environmental stresses, and improve fruit quality by symbiotic microorganisms, including viable mycorrhizal fungi, coexisting in the host plant. The purpose of this technology is completely different from that of the technology to prevent high alkalinity of the soil containing biochar.

### RELATED ART DOCUMENT

### Patent Document

Patent Document 1: JP2015-047130A

### SUMMARY OF THE INVENTION

### Problems to be Solved by the Invention

The present invention advantageously solves the problems described above and aims to provide biochar culture medium that can prevent high alkalinity for a long period of time in cultivating plants using biochar as culture medium, and a method for producing the biochar culture medium.

### Means for Solving the Problems

The present inventors have intensively studied to prevent high alkalinity in cultivating plants using biochar as culture medium and found that culture medium produced by adding a biostimulant material and a beneficial microorganism to biochar can unexpectedly prevent high alkalinity for a long period of time, thereby completing the present invention.

Accordingly, the present invention provides the following [1] to [10]:
[1] Biochar culture medium having pH buffering capacity, containing a biochar, a biostimulant material, and a beneficial microorganism.
[2] The biochar culture medium of [1], wherein the biostimulant material comprises one or two or more selected from humus, organic acids, seaweed extracts, saccharides, minerals, vitamins, peptides, or amino acids.
[3] The biochar culture medium of [1] or [2], wherein the biostimulant material comprises a solid component.

[4] The biochar culture medium of [1] or [2], wherein the beneficial microorganism is one or two or more selected from Pseudomonas spp., Paraburkholderia spp., Trichoderma spp., Bacillus spp., Azospirillum spp., Penicillium spp., Achromobacter spp., mycorrhizal fungi, Yeast, Rhizobia, Ascomycota, Basidiomycota, Staphylococci, Serratia spp., Streptomyces spp., Exophiala spp., Rahnella spp., Citrobacter spp., Gliocladium spp., Klebsiella spp., Alcaligenes spp., Sinorhizobium spp., Aeromonas spp., Azotobacter spp., Rhizobium spp., Rhodobacter spp., Lactobacillus spp., Bradyrhizobium spp., Gluconacetobacter spp., Mesorhizobium spp., Clostridium spp., Enterobacter spp., Phoma spp., Herbaspirillum spp., Geobacter spp., Anaeromyxobacter spp., Burkholderia spp., Methylosinus spp., Ensifer spp., Vibrio spp., Azorhizophilus spp., Mesorhizobium spp., Neorhizobium spp., Cereibacter spp., Tabrizicola spp., Acetilactobacillus spp., Agrilactobacillu spp., Amylolactobacillus spp., Apilactobacillus spp., Bombilactobacillus spp., Companilactobacillus spp., Dellaglioa spp., Fructilactobacillus spp., Furfurilactobacillus spp., Holzapfelia spp., Lacticaseibacillus spp., Lactiplantibacillus spp., Lapidilactobacillus spp., Latilactobacillus spp., Lentilactobacillus spp., Levilactobacillus spp., Ligilactobacillus spp., Limosilactobacillus spp., Liquorilactobacillus spp., Loigolactobacillus spp., Paralactobacillus spp., Paucilactobacillus spp., Schleiferilactobacillus spp., Secundilactobacillus spp., Komagataeibacter spp., Enterocloster spp., Cronobacter spp., Klebsiella spp., Kluyvera spp., Lelliottia spp., Pantoea spp., Pluralibacter spp., Brevundimonas spp., Cobetia spp., Comamonas spp., Curvibacter spp., Delftia spp., Halomonas spp., Hydrogenophaga spp., Marinobacter spp., Marinobacterium spp., Methylobacterium spp., Oceanimonas spp., Pelomonas spp., Ralstonia spp., Sphingomonas spp., Stenotrophomonas spp., Thauera spp., Alicyclobacillus spp., Aneurinibacillus spp., Brevibacillus spp., Geobacillus spp., Lysinibacillus spp., Paenibacillus spp., Sporolactobacillus spp., Sporosarcina spp., Ureibacillus spp., Virgibacillus spp., Geosmithia spp., Hamigera spp., Purpureocillium spp., Thysanophora spp., Eupenicillium spp., Talaromyces spp., Actinoalloteichus spp., Embleya spp., Kitasatospora spp., Saccharopolyspora spp., Streptacidiphilus spp., Yinghuangia spp., photosynthetic bacteria, Cyanobacteria, ammonia-oxidizing bacteria, or nitrite-oxidizing bacteria.
[5] The biochar culture medium of [1], wherein the biochar has a particle size of 0.5 to 20 mm.

[6] A method of producing biochar culture medium having pH buffering capacity, the method comprising the step of adding a biostimulant material and a beneficial microorganism to a biochar.

[7] The method of producing biochar culture medium of [6], wherein the biostimulant material comprises one or two or more selected from humus, organic acids, seaweed extracts, saccharides, minerals, vitamins, peptides, or amino acids.

[8] The method of producing biochar culture medium of [6] or [7], wherein the biostimulant material comprises a solid component.

[9] The method of producing biochar culture medium of [6] or [7], the beneficial microorganism is one or two or more selected from Pseudomonas spp., Paraburkholderia spp., Trichoderma spp., Bacillus spp., Azospirillum spp., Penicillium spp., Achromobacter spp., mycorrhizal fungi, Yeasts, Rhizobia, Ascomycota, Basidiomycota, Staphylococci, Serratia spp., Streptomyces spp., Exophiala spp., Rahnella spp., Citrobacter spp., Gliocladium spp., Klebsiella spp., Alcaligenes spp., Sinorhizobium spp., Aeromonas spp., Azotobacter spp., Rhizobium spp., Rhodobacter spp., Lactobacillus spp., Bradyrhizobium spp., Gluconacetobacter spp., Mesorhizobium spp., Clostridium spp., Enterobacter spp., Phoma spp., Herbaspirillum spp., Geobacter spp., Anaeromyxobacter spp., Burkholderia spp., Methylosinus spp., Ensifer spp., Vibrio spp., Azorhizophilus spp., Mesorhizobium spp., Neorhizobium spp., Cereibacter spp., Tabrizicola spp., Acetilactobacillus spp., Agrilactobacillu spp., Amylolactobacillus spp., Apilactobacillus spp., Bombilactobacillus spp., Companilactobacillus spp., Dellaglioa spp., Fructilactobacillus spp., Furfurilactobacillus spp., Holzapfelia spp., Lacticaseibacillus spp., Lactiplantibacillus spp., Lapidilactobacillus spp., Latilactobacillus spp., Lentilactobacillus spp., Levilactobacillus spp., Ligilactobacillus spp., Limosilactobacillus spp., Liquorilactobacillus spp., Loigolactobacillus spp., Paralactobacillus spp., Paucilactobacillus spp., Schleiferilactobacillus spp., Secundilactobacillus spp., Komagataeibacter spp., Enterocloster spp., Cronobacter spp., Klebsiella spp., Kluyvera spp., Lelliottia spp., Pantoea spp., Pluralibacter spp., Brevundimonas spp., Cobetia spp., Comamonas spp., Curvibacter spp., Delftia spp., Halomonas spp., Hydrogenophaga spp., Marinobacter spp., Marinobacterium spp., Methylobacterium spp., Oceanimonas spp., Pelomonas spp., Ralstonia spp., Sphingomonas spp., Stenotrophomonas spp., Thauera spp., Alicyclobacillus spp., Aneurinibacillus spp., Brevibacillus spp., Geobacillus spp., Lysinibacillus spp., Paenibacillus spp., Sporolactobacillus spp., Sporosarcina spp., Ureibacillus spp., Virgibacillus spp., Geosmithia spp., Hamigera spp., Purpureocillium spp., Thysanophora spp., Eupenicillium spp., Talaromyces spp., Actinoalloteichus spp., Embleya spp., Kitasatospora spp., Saccharopolyspora spp., Streptacidiphilus spp., Yinghuangia spp., photosynthetic bacteria, Cyanobacteria, ammonia-oxidizing bacteria, or nitrite-oxidizing bacteria.

[10] The method of producing biochar culture medium of [6], wherein the biochar has a particle size of 0.5 to 20 mm.

### EFFECTS OF THE INVENTION

The present invention has pH buffering capacity that can prevent high alkalinity for a long period of time in cultivating plants using biochar as culture medium. Thus, the present invention can prevent physiological disorder or poor germination of cultivated plants of concern when the culture medium is highly alkaline, and can do without the use of large amounts of water to reduce high alkalinity, which is thus excellent in economy. In addition, it does not allow propagation of anaerobic microorganisms, and can prevent generation of ammonia gas and maintain a pH suitable for plant growth for a long period of time, which is thus expected to promote plant growth and improve yields.

### BRIEF DESCRIPTION OF THE DRAWINGS

FIG. 1 is a graph showing the results of Experiment 1, represented by the pH changes in the biochar culture medium over time.

FIG. 2 is a graph showing the results of Experiment 2, represented by the pH changes in the biochar culture medium over time.

FIG. 3 is a graph showing the results of Experiment 3, represented by the pH changes in the biochar culture medium over time.

FIG. 4 is a graph showing the results of Experiment 4, represented by the pH changes in the biochar culture medium over time.

FIG. 5 is a graph showing the results of Experiment 5, represented by the pH changes in the biochar culture medium over time.

FIG. 6 is a graph showing the results of Experiment 6, represented by the pH changes in the biochar culture medium over time.

FIG. 7 is a graph showing the results of Experiment 7, represented by the pH changes in the biochar culture medium over time.

FIG. 8 is a graph showing the results of Experiment 7, represented by the changes in generated NO3 concentration in the washing solution over time.

### MODE FOR CARRYING OUT THE INVENTION

The biochar culture medium and the method for producing the biochar culture medium of the present invention are described in more detail below.

The biochar culture medium having pH buffering capacity of the present invention comprises a biochar, a biostimulant material, and a beneficial microorganism. The method for producing biochar culture medium having pH buffering capacity of the present invention comprises the step of adding a biostimulant material and a beneficial microorganism to a biochar. The pH buffering capacity means that, as compared with the case of a biochar only containing a biostimulant material with pH not more than that of the biochar, the case of the biochar containing the biostimulant material and a beneficial microorganism results in prevention of the elevation of the soil pH in the biochar culture medium. For example, as described in Examples, when the pH is not more than 8, preferably not more than 7.5 after 28 days from the production of the biochar culture medium, the biochar culture medium can be evaluated as having pH buffering capacity. The pH measurement can be performed using a commercially available soil pH meter.

The culture medium of the present invention comprises a beneficial microorganism. The reason why inclusion of a beneficial microorganism results in exhibiting pH buffering capacity is not necessarily clear. However, considering that the pH buffering capacity is insufficient if no beneficial microorganism is contained, it is speculated that the beneficial microorganism by itself and/or a biofilm produced by the beneficial microorganism contributes to the pH buffering capacity. For example, biofilms may maintain the low pH of biostimulant materials by physically adsorbing and retaining the biostimulant materials, or biofilms may inhibit the leaching of K⁺ and other pH-elevating components from the biochar by coating the surface of the biochar, or beneficial microorganisms may cause biological adsorption by adsorbing leached K⁺ and releasing H⁺, or beneficial microorganisms may produce acidic substances and release them into the culture medium, or functional groups (such as carboxyl and amino groups) of the biofilm polymer may perform buffering action. Thus, the combination of the selection of beneficial microorganisms and of biostimulant materials that can create an environment in which the beneficial microorganisms can be propagated sufficiently is important for excellent pH buffering capacity.

### Biostimulant Material

Biostimulant materials are materials that control abiotic stresses on plants, thereby reducing plant damage caused by climate and soil conditions and providing healthy plants. A biostimulant material can be contained in the culture medium to promote plant growth or give a positive effect on the soil and increase the yield of plant cultivation. Since the biochar culture medium of the present invention comprises beneficial microorganisms separately from the biostimulant material, microorganisms are removed from the biostimulant material of the present invention.

The pH of the biostimulant material of the present invention is preferably not more than that of the biochar. The pH of the biochar is from 8 to 10, and thus the pH being not more than that of the biochar means that the pH is 8 or less. The pH being not more than that of the biochar allows prevention of high alkalinity due to the leaching of potassium or the like from the biochar. The high alkalinity refers to alkalinity of more than 8 which is the upper limit of suitable pH for plant cultivation, and preferably more than 7.5.

Biostimulant materials with pH of not more than that of biochar include, for example, humus, organic acids, seaweed extracts, saccharides, minerals, vitamins, peptides, and amino acids. Examples of the humus include fulvic acid and phthalic acid. Examples of the organic acids include humic acid, fulvic acid, citric acid, vinegars (such as cider vinegar), and acetic acid. Commercially available seaweed extracts can be used, which may be solid such as powder, or liquid. The saccharides may be monosaccharides such as glucose, or polysaccharides such as chitin and carrageenan, and can be those that produce organic acids through decomposition processes by microorganisms. Examples of the minerals include water-soluble iron such as ferrous and ferrous sulfate, and silicates. Examples of the vitamins include ascorbic acid and vitamin B1. Examples of the amino acids include glutamic acid and 5-aminolevulinic acid.

The biostimulant material is prepared as is or diluted or dissolved in water to prepare an appropriate biostimulant material. In the case of materials in solid form, such as seaweed extract powder, undissolved solid residues may be present after dissolving in water. One or a combination of two or more materials can be used for the biostimulant material. Materials that exhibit acidity will naturally have a pH below the biochar. Materials that exhibit neutrality have the same pH as the biochar, and can be mixed with other materials that exhibit acidity to have a pH lower than the biochar. Materials that exhibit alkalinity can be mixed with materials that exhibit acidity to have a pH lower than the biochar. The preferred pH of the biostimulant material is 5.5 to 7.5, which is suitable for cultivating plants. More preferred pH is 5.5 to 7.0, and still more preferred pH is 5.5 to 6.5.

### Beneficial Microorganism

The beneficial microorganisms include biostimulant microorganisms. Biostimulant microorganisms are applied to the soil to give positive effects on the soil and also to control and enhance the physiological processes in crops, and acting on the plant physiology through pathways different from nutrients to improve crop vigor, yield, quality, and shelf life after harvest.

Examples of the beneficial microorganisms include Pseudomonas spp., Paraburkholderia spp., Trichoderma spp., Bacillus spp., Azospirillum spp., Penicillium spp., Achromobacter spp., mycorrhizal fungi, Yeast, Rhizobia, Ascomycota, Basidiomycota, Staphylococci, Serratia spp., Streptomyces spp., Exophiala spp., Rahnella spp., Citrobacter spp., Gliocladium spp., Klebsiella spp., Alcaligenes spp., Sinorhizobium spp., Aeromonas spp., Azotobacter spp., Rhizobium spp., Rhodobacter spp., Lactobacillus spp., Bradyrhizobium spp., Gluconacetobacter spp., Mesorhizobium spp., Clostridium spp., Enterobacter spp., Phoma spp., Herbaspirillum spp., Geobacter spp., Anaeromyxobacter spp., Burkholderia spp., Methylosinus spp., Ensifer spp., Vibrio spp., Azorhizophilus spp., Mesorhizobium spp., Neorhizobium spp., Cereibacter spp., Tabrizicola spp., Acetilactobacillus spp., Agrilactobacillu spp., Amylolactobacillus spp., Apilactobacillus spp., Bombilactobacillus spp., Companilactobacillus spp., Dellaglioa spp., Fructilactobacillus spp., Furfurilactobacillus spp., Holzapfelia spp., Lacticaseibacillus spp., Lactiplantibacillus spp., Lapidilactobacillus spp., Latilactobacillus spp., Lentilactobacillus spp., Levilactobacillus spp., Ligilactobacillus spp., Limosilactobacillus spp., Liquorilactobacillus spp., Loigolactobacillus spp., Paralactobacillus spp., Paucilactobacillus spp., Schleiferilactobacillus spp., Secundilactobacillus spp., Komagataeibacter spp., Enterocloster spp., Cronobacter spp., Klebsiella spp., Kluyvera spp., Lelliottia spp., Pantoea spp., Pluralibacter spp., Brevundimonas spp., Cobetia spp., Comamonas spp., Curvibacter spp., Delftia spp., Halomonas spp., Hydrogenophaga spp., Marinobacter spp., Marinobacterium spp., Methylobacterium spp., Oceanimonas spp., Pelomonas spp., Ralstonia spp., Sphingomonas spp., Stenotrophomonas spp., Thauera spp., Alicyclobacillus spp., Aneurinibacillus spp., Brevibacillus spp., Geobacillus spp., Lysinibacillus spp., Paenibacillus spp., Sporolactobacillus spp., Sporosarcina spp., Ureibacillus spp., Virgibacillus spp., Geosmithia spp., Hamigera spp., Purpureocillium spp., Thysanophora spp., Eupenicillium spp., Talaromyces spp., Actinoalloteichus spp., Embleya spp., Kitasatospora spp., Saccharopolyspora spp., Streptacidiphilus spp., Yinghuangia spp., photosynthetic bacteria, Cyanobacteria, ammonia-oxidizing bacteria, and nitrite-oxidizing bacteria. One or two or more of these microorganisms can be used.

Examples of commercially available beneficial microorganisms include the trade name “Kinryoku-Up” from Daichi No Inochi Co. Ltd. Kinryoku-Up is a soil amendment that contains aerobic soil microorganisms, such as Actinomyces (Streptomyces spp.), nitrifying bacteria, Rhizobia, Azotobacter, sulfur bacteria, photosynthetic bacteria, fiber nitrogen-decomposing bacteria, Yeast, and thermophiles, and contains 250 microorganisms.

The beneficial microorganisms are preferably contained in the range from 1×10² to 1×10⁸ cfu/100 mL, as the microbial biomass per 100 mL biochar. The microbial biomass can also be adjusted in combination with the biostimulant material such that the pH of the biochar culture medium is not more than that of the biochar. For example, Yeast, though the cause is not necessarily clear, whether it is due to the yeast releasing acidic substances, may cause the pH of the biochar culture medium to be below 5.5. In that case, the amount of Yeast is adjusted to reduce the amount.

### Biochar

Examples of the biochar include charcoals that are plant-derived chars, bamboo charcoals, chars derived from grasses and trees, nut-derived chars, rice husks, rice straw-derived chars, plant residue-derived chars, sewage sludge-derived chars, paper sludge-derived chars, and livestock excreta-derived chars. One or two or more of these biochars can be used. The particle size of the biochar is preferably from 0.5 to 20 mm. This is because a particle size of less than 0.5 mm results in too high water holding capacity, leading to moisturization and anaerobic conditions, while a particle size of more than 20 mm results in too high water drainage, leading to poor water retention. More preferably, the particle size is from 1 to 10 mm, and still more preferably from 1 to 5 mm.

### Additional Component

The biochar culture medium of the present invention, basically comprising a biochar, a biostimulant material, and a beneficial microorganism as described above, may comprise other additional components. Examples of the additional components include functional components derived from animals or plants, microbial metabolites, and microorganism activation materials.

### Production Method

The biochar culture medium of the present invention is produced by the following method as an example. A biochar, a previously prepared biostimulant material, a beneficial microorganism, and as needed other additional components are prepared. This biostimulant material has been previously prepared, as needed, by diluting or dissolving a biostimulant material with water into suitable pH not more than that of the biochar. Next, to the biochar are added the biostimulant material, the beneficial microorganism, and as needed the other additional components. More specifically, the addition is to pour the biostimulant material, the beneficial microorganism, and other materials to the biochar, or to immerse the biochar in a container containing the biostimulant material and the beneficial microorganism to mix the components. The order of mixing is not restricted and may be simultaneous.

### EXAMPLES

The present invention is described in more detail with reference to the Examples below.

### Experiment 1

### Example 1

300 mL of rice husk biochar was soaked in 300 mL of 50-fold dilution of a commercially available 10% cider vinegar (final concentration of 0.2%) for 1 day.

Thereafter, 30 mL of 50-fold dilution of the trade name “Kinryoku-Up from Daichi No Inochi Co. Ltd.” was added to obtain a biochar culture medium. After 0, 3, 7, 14, 21, and 28 days, the pH was measured using a soil pH meter PRN-41 from Fujiwara Scientific Co., Ltd. by inserting the electrodes of the soil pH meter into the biochar culture medium. After the measurement with the pH meter, the rice husk biochar was washed with 100 ml of water and left to stand in order to keep the rice husk biochar in a wet state and apply load in an acceleration test manner.

### Comparative Example 1

300 mL of rice husk biochar was soaked in 300 mL of water for 1 day to obtain a biochar culture medium. No beneficial microorganisms were added. The pH was measured in the same manner as in Example 1.

### Comparative Example 2

300 mL of rice husk biochar was soaked in 300 mL of 50-fold dilution of a commercially available cider vinegar for 1 day to obtain a biochar culture medium. No beneficial microorganisms were added. The pH was measured in the same manner as in Example 1.

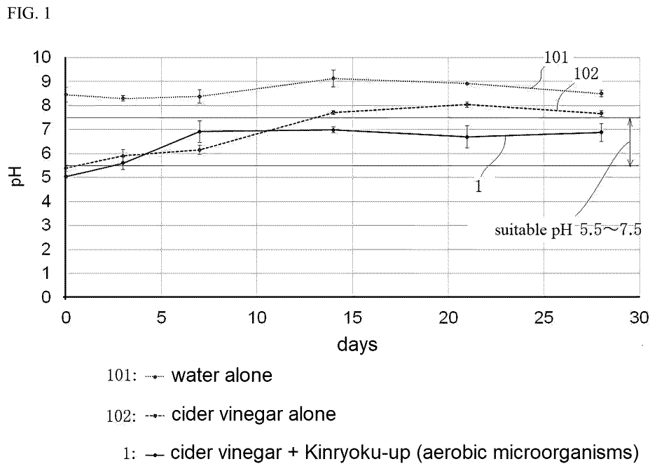

The changes in pH of the biochar culture medium of Example 1, Comparative Example 1, and Comparative Example 2 are graphically shown in FIG. 1. As shown in FIG. 1, in Comparative Examples 1 and 2, the pH was in the suitable range of 5.5 to 7.5 within 2 weeks. On the other hand, in Example 1, the pH was successfully kept in the suitable range of 5.5 to 7.5 over 4 weeks (28 days). Therefore, it is demonstrated that inclusion of a biostimulant material and a microorganism results in excellent pH buffering capacity.

### Experiment 2

### Example 2

300 mL of rice husk biochar was soaked in 300 mL of 50-fold dilution of a commercially available liquid seaweed extract (TMG-SCL 001) for 1 day. Thereafter, 30 mL of 50-fold dilution of the trade name “Kinryoku-Up from Daichi No Inochi Co. Ltd.” was added to obtain a biochar culture medium. After 0, 3, 7, 14, 21, and 28 days, the pH was measured using a soil pH meter in the same manner as in Example 1. After the measurement with the pH meter, the biochar culture medium was washed with 100 ml of water and left to stand.

### Comparative Example 3

300 mL of rice husk biochar was soaked in 300 mL of 50-fold dilution of a commercially available liquid seaweed extract (TMG-SCL 001) for 1 day to obtain a biochar culture medium. No beneficial microorganisms were added. The pH was measured in the same manner as in Examples 1 and 2.

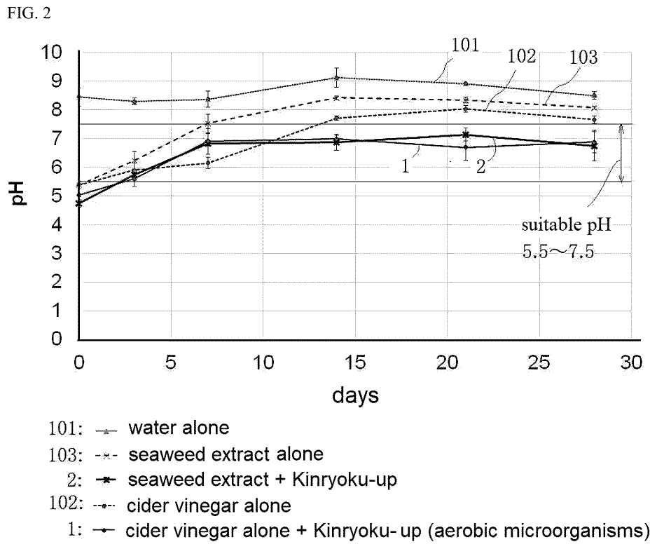

The changes in pH of the biochar culture medium of Example 2 and Comparative Example 3 are graphically shown in FIG. 2. FIG. 2 also shows the changes in pH of Example 1, Comparative Example 1, and Comparative Example 2 together. As shown in FIG. 2, in Example 2 using a seaweed extract with lower pH than biochar as a biostimulant material, the pH was successfully kept in the suitable range of 5.5 to 7.5 over 4 weeks (28 days) as in Example 1. On the other hand, in Comparative Example 3 using a seaweed extract with lower pH than biochar as a biostimulant material but not containing any beneficial microorganism, the pH was in a suitable range of 5.5 to 7.5 within 1 week. Therefore, it is demonstrated that the biostimulant material is not restricted to organic acids, and biostimulant materials with lower pH than biochar are useful.

### Experiment 3

300 mL of rice husk biochar was soaked in 300 mL of 50-fold dilution of a commercially available cider vinegar for 1 day. Thereafter, a beneficial microorganism of the type and amount shown below was added to obtain a biochar culture medium. After 0, 3, 7, 14, 21, and 28 days, the pH was measured using a soil pH meter in the same manner as in Examples 1 and 2. After the measurement with the pH meter, the biochar culture medium was washed with 100 ml of water and left to stand.

### Example 3

30 mL of 1000-fold dilution of a photosynthetic bacterium (purple non-sulfur bacterium THE-PSB005)

### Example 4

30 mL of 500-fold dilution of Bacillus bacterium (TDK-BCP 001)

### Example 5

30 mL of 100-fold dilution of Trichoderma bacterium (KASSEI TRICHO)

### Example 6

1 g of yeast (SHOUWA KOUSO Hi-S)

### Example 7

30 mL of 400-fold dilution of lactic acid bacterium (TMG-NSBD 01)

### Example 8

30 mL of 1000-fold dilution of arbuscular mycorrhizal fungus (MYCOGEL TKK-HPMCG 100)

### Example 9

1 g of Actinomyces (Streptomyces spp.) (“DR-HOUSENKIN” from ALM Agricultural Material)

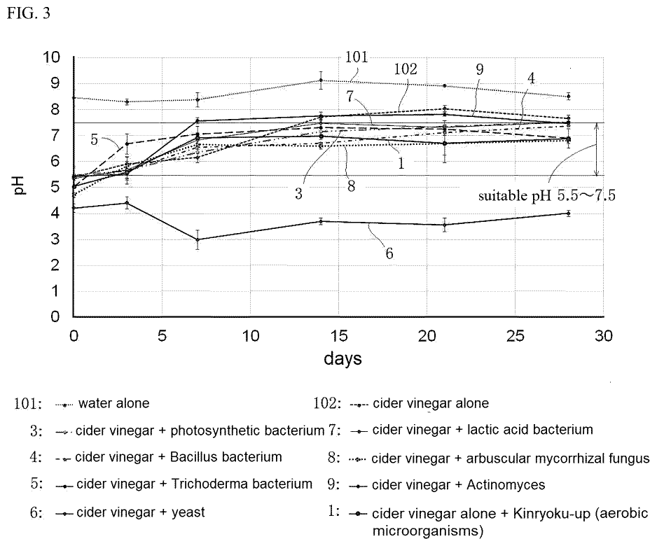

The changes in pH of the biochar culture medium of Examples 3 to 9 are graphically shown in FIG. 3. FIG. 3 also shows the changes in pH of Example 1, Comparative Example 1, and Comparative Example 2 together.

As shown in FIG. 3, in Examples 3 to 5, 7 and 8 using various beneficial microorganisms, the pH was successfully kept in the suitable range of 5.5 to 7.5 over 4 weeks (28 days) as in Example 1. In the case using the yeast of Example 6, though the cause is not clear, whether it is due to the yeast releasing acidic substances, the pH was below 5.5.

However, it is noted that by adjusting the amount of the yeast, or depending on the selection of the biostimulant material, the pH can be kept in the suitable range of 5.5 to 7.5. For Actinomyces in Example 9, the pH was in the suitable range of 5.5 to 7.5 within 1 week. However, it is noted that by adjusting the amount of the Actinomyces, or depending on the selection of the biostimulant material, the pH can be kept in the suitable range of 5.5 to 7.5 over 4 weeks.

### Experiment 4

300 mL of rice husk biochar was soaked in 300 mL of 50-fold dilution of a commercially available cider vinegar for 1 day. Thereafter, a beneficial microorganism of the type and amount shown below was added to obtain a biochar culture medium. After 0, 3, 7, 14, 21, and 28 days in the same manner as in Examples 1 and 2, the pH was measured using a soil pH meter in the same manner as in Example 1. After the measurement with the pH meter, the biochar culture medium was washed with 100 ml of water and left to stand.

### Example 10

1 g of MASTERPIECE wettable powder (Pseudomonas) from Nisso Green Co., Ltd.

### Example 11

1 g of BIORAIZA (Bacillus sp. LB-5, Paenibacillus sp. BS-1 SMCPIII, Priestia sp. KC-6, Talaromyces sp. CF-1, Penicillium sp. LF-3, Zalaria sp. LB-31) from Katakura & Co-op Agri Corporation

### Example 12

1 g of Yeast (BLOF Yeast from Japan Biofarm Co., Ltd.)

### Example 13

1 mL of Azospirillum(NBRC 102289 : Azospirillum brasilense, purchased from NITE Biological Resource Center) culture

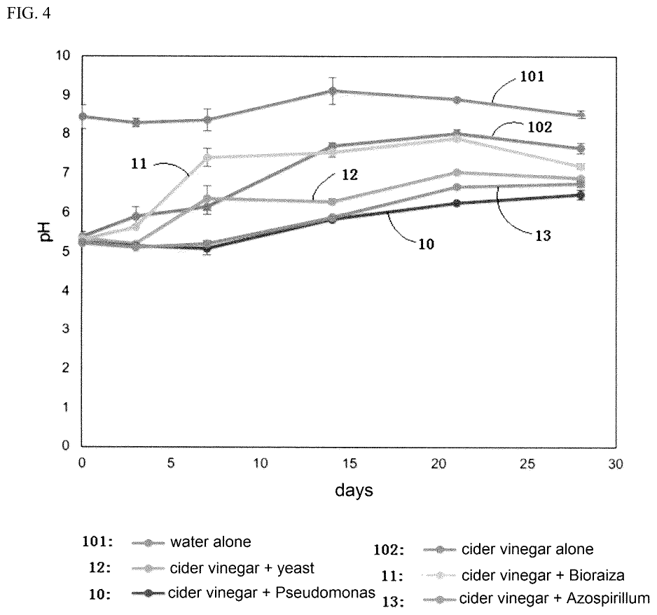

The changes in pH of the biochar culture medium of Examples 10 to 13 are graphically shown in FIG. 4. FIG. 4 also shows the changes in pH of Comparative Example 1 and Comparative Example 2 together.

As shown in FIG. 4, in Examples 10, 12, and 13 using various beneficial microorganisms, the pH was successfully regulated below pH 7.5 over 4 weeks (28 days). BIORAIZA of Example 11 allowed the pH value to be lower than Comparative Examples 1 and 2, and the pH was below 7.5 after 28 days. Similarly for BIORAIZA, by adjusting the types or amounts of the bacteria, or depending on the selection of the biostimulant material, the pH can be kept in the suitable range of 5.5 to 7.5 over 4 weeks.

### Experiment 5

### Example 14

300 mL of rice husk biochar was soaked in 300 mL of 600-fold dilution of citric acid (final concentration of 0.2%) for 1 day. Thereafter, 30 mL of 100-fold dilution of the trade name “Kinryoku-Up from Daichi No Inochi Co. Ltd.” was added to obtain a biochar culture medium. After 0, 3, 7, 14, 21, and 28 days, the pH was measured using a soil pH meter in the same manner as in Example 1. After the measurement with the pH meter, the biochar culture medium was washed with 100 ml of water and left to stand.

### Comparative Example 4

300 mL of rice husk biochar was soaked in 300 ml of water for 1 day to obtain a biochar culture medium. Thereafter, the pH was measured in the same manner as in Example 14.

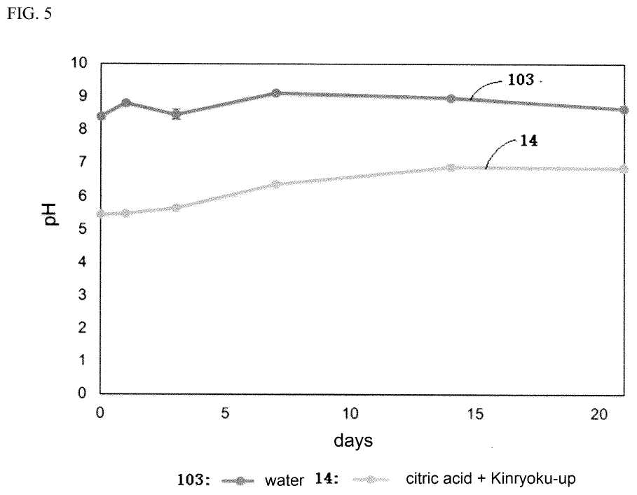

The changes in pH of the biochar culture medium of Example 14 and Comparative Example 4 are graphically shown in FIG. 5. It was found from FIG. 5 that the effect of water alone resulted in elevation of the pH to 7.5 or more, but addition of citric acid allowed the pH to be kept below 7.5.

### Experiment 6

### Example 15

To 300 mL of rice husk biochar, 1.2 g of glucose (FUJIFILM Wako Pure Chemical Corporation) as a saccharide was added, followed by addition of a bark compost (SANYO BARK from Sanyo Chip Co., Ltd.) containing aerobic microorganisms (including Actinomyces, nitrite oxidizing bacteria, and ammonia oxidizing bacteria), and then of 30 mgN/100 mL of an organic fertilizer (BIONO ORGANIC S, from Taiseinozai Co., Ltd.), and the mixture was left to stand at 25 °C to obtain a biochar culture medium. Finally, after 7, 14, 21, and 28 days, the biochar culture medium was washed with 300 ml of water, and then the pH of the washing solution was measured using a pH meter LAQUA twin pH-22B from Horiba, Ltd.

### Comparative Example 5

To 300 mL of rice husk biochar, a bark compost (SANYO BARK from Sanyo Chip Co., Ltd.) containing aerobic microorganisms was added, followed by addition of 30 mgN/100 mL of an organic fertilizer (BIONO ORGANIC S, from Taiseinozai Co., Ltd.), and the mixture was left to stand at 25 °C to obtain a biochar culture medium. Finally, after 7, 14, 21, and 28 days, the biochar culture medium was washed with 300 ml of water, and then the pH of the washing solution was measured in the same manner as in Example 15.

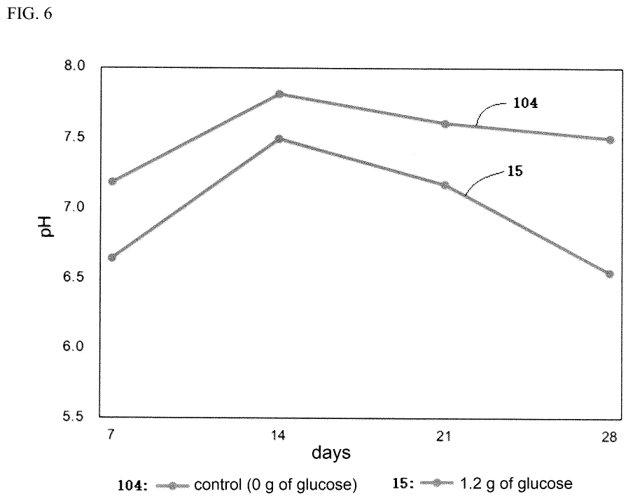

The changes in pH of the biochar culture medium of Example 15 and Comparative Example 5 are graphically shown in FIG. 6. As shown in FIG. 6, glucose by itself is not a material of low pH, but organic acids produced in the process of its decomposition by microorganisms decreased the pH of the biochar.

### Experiment 7

### Example 16

To 300 mL of poultry manure char, 18 g of a mineral material mainly containing water-soluble iron sulfate (Iron-T, from Japan Biofarm Co., Ltd.) was added, followed by addition of a bark compost (SANYO BARK from Sanyo Chip Co., Ltd.) containing aerobic microorganisms (including Actinomyces, nitrite oxidizing bacteria, and ammonia oxidizing bacteria), and then of 6 mgN/100 mL of an organic fertilizer (bonito broth, from Makurazaki marine products processing industries cooperative.), to obtain a biochar culture medium.

Finally, after 7, 14, 21, and 28 days, the biochar culture medium was washed with 300 mL of water, and then the pH of and NO₃⁻ production in the washing solution were measured. The pH measurement was performed using a pH meter LAQUA twin pH-22B from Horiba, Ltd. The NO₃⁻ production was measured using RQflex plus 10 from Merck KGaA. After the washing, 6 mgN/100 mL of the organic fertilizer was again added and left to stand at 25 °C

### Comparative Example 6

To 300 mL of poultry manure char, a bark compost (SANYO BARK from Sanyo Chip Co., Ltd.) containing aerobic microorganisms was added, followed by addition of 30 mgN/100 mL of an organic fertilizer (bonito broth, Makurazaki marine products processing industries cooperative.), to obtain a biochar culture medium. Finally, after 7, 14, 21, and 28 days, the biochar culture medium was washed with 300 mL of water, and then the pH of and NO₃⁻ production in the washing solution were measured in the same manner as in Example 16. After the washing, 6 mgN/100 mL of the organic fertilizer was again added and left to stand at 25 °C

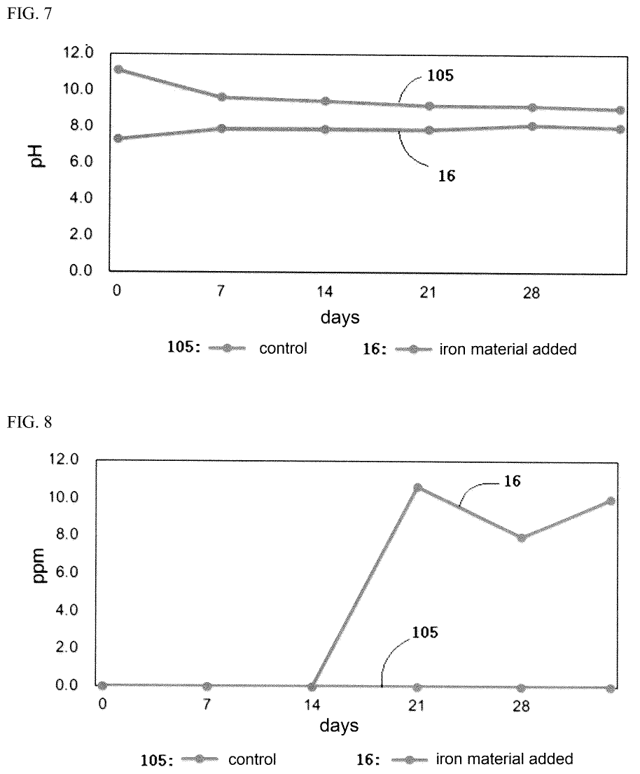

The changes in pH of the biochar culture medium of Example 16 and Comparative Example 6 are graphically shown in FIG. 7. The changes in the produced NO₃⁻ concentration in the washing solution after washing of the biochar culture medium of Example 16 and Comparative Example 6 are graphically shown in FIG. 8.

As shown in FIG. 7 and FIG. 8, it is demonstrated that use of the water-soluble iron material and the microorganisms allows the pH to be kept below 8 even for poultry manure char with very high pH of 11 or more. Conventionally, it is not possible to co-culture ammonifying bacteria and nitrifying bacteria in poultry manure char with high pH, but it is demonstrated that combination of the present technology enables culture of nitrifying bacteria and can impart a nitric acid producing function. Adjustment of the addition amount allows adjustment of the pH below 7.5.

1. Biochar culture medium having pH buffering capacity, comprising a biochar, a biostimulant material, and a beneficial microorganism.

2. The biochar culture medium of claim 1, wherein the biostimulant material comprises one or two or more selected from humus, organic acids, seaweed extracts, saccharides, minerals, vitamins, peptides, or amino acids.

3. The biochar culture medium of claim wherein the biostimulant material comprises a solid component.

4. The biochar culture medium of claim wherein the beneficial microorganism is one or two or more selected from Pseudomonas spp., Paraburkholderia spp., Trichoderma spp., Bacillus spp., Azospirillum spp., Penicillium spp., Achromobacter spp., mycorrhizal fungi, Yeast, Rhizobia, Ascomycota, Basidiomycota, Staphylococci, Serratia spp., Streptomyces spp., Exophiala spp., Rahnella spp., Citrobacter spp., Gliocladium spp., Klebsiella spp., Alcaligenes spp., Sinorhizobium spp., Aeromonas spp., Azotobacter spp., Rhizobium spp., Rhodobacter spp., Lactobacillus spp., Bradyrhizobium spp., Gluconacetobacter spp., Mesorhizobium spp., Clostridium spp., Enterobacter spp., Phoma spp., Herbaspirillum spp., Geobacter spp., Anaeromyxobacter spp., Burkholderia spp., Methylosinus spp., Ensifer spp., Vibrio spp., Azorhizophilus spp., Mesorhizobium spp., Neorhizobium spp., Cereibacter spp., Tabrizicola spp., Acetilactobacillus spp., Agrilactobacillu spp., Amylolactobacillus spp., Apilactobacillus spp., Bombilactobacillus spp., Companilactobacillus spp., Dellaglioa spp., Fructilactobacillus spp., Furfurilactobacillus spp., Holzapfelia spp., Lacticaseibacillus spp., Lactiplantibacillus spp., Lapidilactobacillus spp., Latilactobacillus spp., Lentilactobacillus spp., Levilactobacillus spp., Ligilactobacillus spp., Limosilactobacillus spp., Liquorilactobacillus spp., Loigolactobacillus spp., Paralactobacillus spp., Paucilactobacillus spp., Schleiferilactobacillus spp., Secundilactobacillus spp., Komagataeibacter spp., Enterocloster spp., Cronobacter spp., Klebsiella spp., Kluyvera spp., Lelliottia spp., Pantoea spp., Pluralibacter spp., Brevundimonas spp., Cobetia spp., Comamonas spp., Curvibacter spp., Delftia spp., Halomonas spp., Hydrogenophaga spp., Marinobacter spp., Marinobacterium spp., Methylobacterium spp., Oceanimonas spp., Pelomonas spp., Ralstonia spp., Sphingomonas spp., Stenotrophomonas spp., Thauera spp., Alicyclobacillus spp., Aneurinibacillus spp., Brevibacillus spp., Geobacillus spp., Lysinibacillus spp., Paenibacillus spp., Sporolactobacillus spp., Sporosarcina spp., Ureibacillus spp., Virgibacillus spp., Geosmithia spp., Hamigera spp., Purpureocillium spp., Thysanophora spp., Eupenicillium spp., Talaromyces spp., Actinoalloteichus spp., Embleya spp., Kitasatospora spp., Saccharopolyspora spp., Streptacidiphilus spp., Yinghuangia spp., photosynthetic bacteria, Cyanobacteria, ammonia-oxidizing bacteria, or nitrite-oxidizing bacteria.

5. The biochar culture medium of claim 1, wherein the biochar has a particle size of 0.5 to 20 mm.

6. A method of producing biochar culture medium having pH buffering capacity, the method comprising the step of adding a biostimulant material and a beneficial microorganism to a biochar.

7. The method of producing biochar culture medium of claim 6, wherein the biostimulant material comprises one or two or more selected from humus, organic acids, seaweed extracts, saccharides, minerals, vitamins, peptides, or amino acids.

8. The method of producing biochar culture medium of claim wherein the biostimulant material comprises a solid component.

9. The method of producing biochar culture medium of claim 6, wherein the beneficial microorganism is one or two or more selected from Pseudomonas spp., Paraburkholderia spp., Trichoderma spp., Bacillus spp., Azospirillum spp., Penicillium spp., Achromobacter spp., mycorrhizal fungi, Yeasts, Rhizobia, Ascomycota, Basidiomycota, Staphylococci, Serratia spp., Streptomyces spp., Exophiala spp., Rahnella spp., Citrobacter spp., Gliocladium spp., Klebsiella spp., Alcaligenes spp., Sinorhizobium spp., Aeromonas spp., Azotobacter spp., Rhizobium spp., Rhodobacter spp., Lactobacillus spp., Bradyrhizobium spp., Gluconacetobacter spp., Mesorhizobium spp., Clostridium spp., Enterobacter spp., Phoma spp., Herbaspirillum spp., Geobacter spp., Anaeromyxobacter spp., Burkholderia spp., Methylosinus spp., Ensifer spp., Vibrio spp., Azorhizophilus spp., Mesorhizobium spp., Neorhizobium spp., Cereibacter spp., Tabrizicola spp., Acetilactobacillus spp., Agrilactobacilluspp., Amylolactobacillus spp., Apilactobacillus spp., Bombilactobacillus spp., Companilactobacillus spp., Dellaglioa spp., Fructilactobacillus spp., Furfurilactobacillus spp., Holzapfelia spp., Lacticaseibacillus spp., Lactiplantibacillus spp., Lapidilactobacillus spp., Latilactobacillus spp., Lentilactobacillus spp., Levilactobacillus spp., Ligilactobacillus spp., Limosilactobacillus spp., Liquorilactobacillus spp., Loigolactobacillus spp., Paralactobacillus spp., Paucilactobacillus spp., Schleiferilactobacillus spp., Secundilactobacillus spp., Komagataeibacter spp., Enterocloster spp., Cronobacter spp., Klebsiella spp., Kluyvera spp., Lelliottia spp., Pantoea spp., Pluralibacter spp., Brevundimonas spp., Cobetia spp., Comamonas spp., Curvibacter spp., Delftia spp., Halomonas spp., Hydrogenophaga spp., Marinobacter spp., Marinobacterium spp., Methylobacterium spp., Oceanimonas spp., Pelomonas spp., Ralstonia spp., Sphingomonas spp., Stenotrophomonas spp., Thauera spp., Alicyclobacillus spp., Aneurinibacillus spp., Brevibacillus spp., Geobacillus spp., Lysinibacillus spp., Paenibacillus spp., Sporolactobacillus spp., Sporosarcina spp., Ureibacillus spp., Virgibacillus spp., Geosmithia spp., Hamigera spp., Purpureocillium spp., Thysanophora spp., Eupenicillium spp., Talaromyces spp., Actinoalloteichus spp., Embleya spp., Kitasatospora spp., Saccharopolyspora spp., Streptacidiphilus spp., Yinghuangia spp., photosynthetic bacteria, Cyanobacteria, ammonia-oxidizing bacteria, or nitrite-oxidizing bacteria.

10. The method of producing biochar culture medium of claim 6, wherein the biochar has a particle size of 0.5 to 20 mm.
